(19) United States
(12) Patent Application Publication
(10) Pub. No.: US 2024/0256331 A1
(43) Pub. Date: Aug. 1, 2024

(54) MULTI-PHASE PROVISIONING

(71) Applicant: Salesforce, inc., San Francisco, CA (US)

(72) Inventors: Liang Xie, Los Altos, CA (US); Billy Ma, San Mateo, CA (US); Jatinkumar Patel, Union City, CA (US); Aaron Chan, San Ramon, CA (US)

(21) Appl. No.: 18/160,136

(22) Filed: Jan. 26, 2023

(51) Int. Cl. G06F 9/48; G06F 9/50

(52) U.S. Cl. CPC G06F 9/4881; G06F 9/5072; G06F 9/5077; G06F 2209/5011

(57) ABSTRACT

Approaches for data processing at a database system are described. A method may include identifying a first subset of provisioning tasks associated with a first phase of the multi-phase provisioning procedure and a second subset of provisioning tasks associated with a second phase of the multi-phase provisioning procedure. The method may include running the first subset of provisioning tasks on a plurality of software instances of a pool of software instances prior to a provisioning request for the software instance. The method may include receiving, from a user, the provisioning request. The method may include running, based at least in part on the provisioning request and on the software instance from the pool of software instances, the second subset of provisioning tasks, wherein the second subset of provisioning tasks are specific to the user. The method may include provisioning the software instance to the user.

### FIELD OF TECHNOLOGY

The present disclosure relates generally to database systems and data processing, and more specifically to multi-phase provisioning.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some approaches, a cloud platform may provision a software instance for use by a user. However, such approaches may be improved.

### BRIEF DESCRIPTION OF THE DRAWINGS

FIG. 1 illustrates an example of a data processing system that supports multi-phase provisioning in accordance with examples as disclosed herein.

FIG. 2 illustrates an example of a data processing system that supports multi-phase provisioning in accordance with examples as disclosed herein.

FIG. 3 illustrates an example of a provisioning scheme that supports multi-phase provisioning in accordance with examples as disclosed herein.

FIG. 4 illustrates an example of a provisioning scheme that supports multi-phase provisioning in accordance with examples as disclosed herein.

FIG. 5 illustrates an example of a process flow that supports multi-phase provisioning in accordance with examples as disclosed herein.

FIG. 6 illustrates a block diagram of an apparatus that supports multi-phase provisioning in accordance with examples as disclosed herein.

FIG. 7 illustrates a block diagram of a provisioning manager that supports multi-phase provisioning in accordance with examples as disclosed herein.

FIG. 8 illustrates a diagram of a system including a device that supports multi-phase provisioning in accordance with examples as disclosed herein.

FIGS. 9 through 11 illustrate flowcharts showing methods that support multi-phase provisioning in accordance with examples as disclosed herein.

### DETAILED DESCRIPTION

Users of a cloud computing system may employ different features and configurations for a user environment on the cloud computing system based on their individual use cases. To accommodate such different use cases, different features, configurations, metadata, and other information may be provisioned for the user environment. However, in some cases, the provisioning may be performed in accordance with reliability and timeline constraints. For example, it may be desirable to complete the provisioning before the user arrives at a home page for the user's environment on the cloud system. Otherwise, the user may arrive at the home page or a similar user interface and aspects of the environment or application instance may still be inoperable. Similarly, it may be desirable to perform updates to the cloud computing environment. Further, as larger amounts of data and more complex cloud computing environments are utilized, delays for provisioning have increased.

A database system may divide the provisioning process into multiple phases. A first phase may include “static” provisioning tasks that may be widely-applicable to different users. A second phase may include “dynamic” provisioning tasks that may be on-demand or user specific. The first phase may include initializing one or more software instances and performing the “static” provisioning tasks on the initialized software instances. After a user requests provisioning, the second phase may be entered in which the “dynamic” provisioning tasks may be performed using one or more of the software instances on which the “static” provisioning tasks were already performed. In this way, many provisioning tasks may be performed in the first phase, before the user requests provisioning, resulting in reduced provisioning time, more efficient use of computing resources, and providing a more satisfying user experience.

In some examples, the database system may assign tasks to the first phase or the second phase based on one or more characteristics of the tasks. For example, the tasks may include a dynamicity characteristic (e.g., whether a task is a dynamic task or a static task or falls in a portion of a dynamicity spectrum), a race condition characteristic (e.g., whether the task is associated with a race condition where an order of performing tasks may change a related outcome or where tasks are performed in an order), a timing characteristic (e.g., whether a task is to be completed before a point in time that may be associated with one or more other events in the provisioning process), or any combination thereof. In some examples, tasks may be split into multiple sub-tasks based on such characteristics and the sub-tasks may be assigned to phases. In some examples, if a task assigned to the first phase fails, a second attempt at performing the task may be performed in the second phase. In some examples, a template designating or indicating one or more tasks may be used to perform tasks in the first phase, the second phase, or both. In some examples, software instances may be pre-configured (e.g., partially or completely) with one or more tasks already performed on the software instances (e.g., even before the first phase takes place).

Aspects of the disclosure are initially described in the context of an environment supporting an on-demand database service. Aspects of the disclosure are then described with reference to a data processing system, provisioning schemes, and a process flow: Aspects of the disclosure are further illustrated by and described with reference to apparatus diagrams, system diagrams, and flowcharts that relate to multi-phase provisioning.

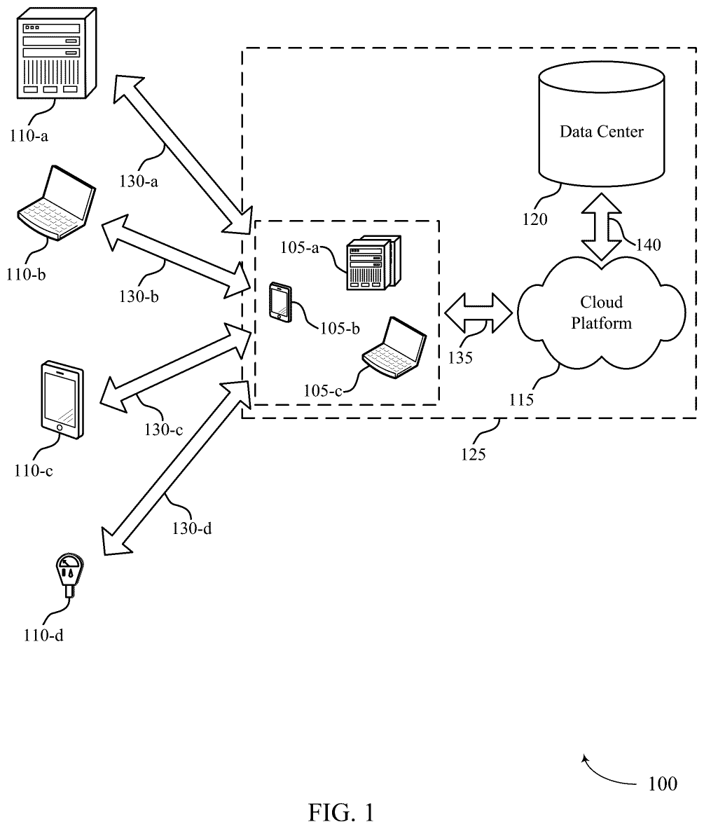

FIG. 1 illustrates an example of a system 100 for cloud computing that supports multi-phase provisioning in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some implementations, the cloud platform 115 may engage in a multi-phase provisioning procedure that includes multiple provisioning tasks. For example, the cloud platform 115 may assign a first subset of tasks to a first phase of the provisioning procedure and may assign a second subset of tasks to a second phase of the provisioning procedure. The first phase of tasks may be performed prior to receiving a provisioning request from a user (e.g., a client 105) and the second phase of tasks may be performed after receiving the provisioning request. The first phase of tasks may include tasks that may not be user-specific or user-dependent, that may be completed before other tasks are completed, or may not receive regular updates (e.g., from a cloud or SaaS control plane), for example. The second phase of tasks may include tasks that may be user-specific or user-dependent, that are to be completed after completion of one or more other tasks (e.g., a race condition), or tasks that may be updated regularly.

Provisioning software instances for a user often involves many provisioning tasks that are to be performed on a timeline so that features, configurations, or metadata are prepared and ready for use by the user. However, technical problems are present in other approaches for provisioning that simply receive a request for provisioning and subsequently begin performing such provisioning tasks, leading to excessive delays and inefficient computational resource usage while the provisional tasks are performed, causing the user to experience delays while the provisioning tasks are performed before the software instance is made available to the user for use. These approaches tend to treat provisioning tasks equally or without regard to differing characteristics of individual provisioning tasks. As computing environments become more complex and handle larger amounts of data, delays in provisioning are increased due to the amount of configuration and setup that is performed to provision the software instances. Additionally, if tasks are performed after a user requests provisioning and one of these tasks fails, further delays and computational expenses are incurred to re-do the task or correct errors resulting from the failure of the task.

The subject matter described herein describes solutions that resolve such technical problems. For example, by assigning some tasks (e.g., those that may be more generally applicable to multiple users or are tasks associated with a race condition) to a first phase of a provisioning procedure before a user requests provisioning of a software instance, a cloud system or application server may reduce the quantity of tasks that are to be performed after the user requests provisioning of the software instance. In some examples, such a first phase may be used for preparing one or more software instances before receiving some or all user requests related to provisioning of one or more software instances. As such, in some examples, tasks performed in the first phase may be described as “pre-processing” and may not be counted or considered in a time duration for provisioning a software instance. Additionally, tasks that may involve large amounts of data or significant processing time may be performed in the first phase, thereby reducing the delay or quantity of tasks performed after the user requests provisioning. Tasks that are less important or that are not subject to a timing consideration may be performed in a second phase that may occur after the user requests provisioning. Additionally, in examples in which a task assigned to the first phase fails, the task may be attempted again in the second phase, which reduces delays after the provisioning request compared to a failure occurring in the second phase alone.

For example, a user may request provisioning of a software instance from the cloud platform 115 (e.g., via a client 105). However, even before the user has requested provisioning, the cloud platform 115 may have already run a set of first tasks in a first provisioning phase on the software instance from a software instance pool. As described herein, these first tasks may include tasks that are not specific to the user or may be of a higher priority or importance than other tasks. In response to the user requesting the provisioning, the cloud platform 115 may run a set of second tasks in a second provisioning phase on the same software instance that is now assigned to or associated with the user that requested the provisioning, and the software instance may be made available to the user. In this way, the quantity or complexity of tasks performed after the provisioning request is received may be reduced and the provisioned software instance may be provided to the user more quickly without reducing a quantity of available features or configuration or compromising features, layout, or other configuration of the software instance.

It should be appreciated by a person skilled in the art that one or more aspects of the disclosure may be implemented in a system 100 to additionally or alternatively solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

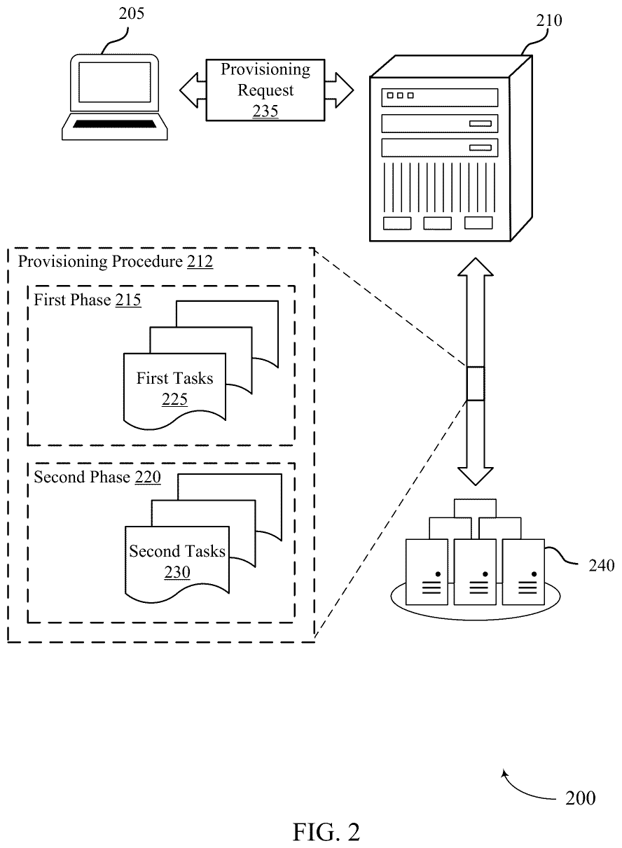

FIG. 2 illustrates an example of a data processing system 200 that supports multi-phase provisioning in accordance with examples as disclosed herein. The data processing system 200 may include a client 205 and a server 210. The server 210 may be associated with a cloud platform (e.g., cloud platform 115 described herein). A software instance pool 240 may also be associated with the cloud platform. Elements of the data processing system 200 may perform one or more portions of the provisioning procedure 212 as described herein.

The provisioning procedure 212 may include various tasks that are to be completed without errors or, in some examples, at least some of which are to be completed by the time that a user accesses the provisioned software instance. For example, tasks that set configurations or settings for a computing environment or a software instance may be performed relatively quickly as compared to tasks associated with metadata deployment (e.g., that may be performed via an async application programming interface (API)). Further, the data processing system 200 may handle increasing quantities of requests for such metadata deployment, further emphasizing the desirability of reduced setup time. Additionally, or alternatively, if a task fails, additional time may be consumed for one or more additional attempts at performing the task. Additionally, or alternatively, a race condition may be associated with one or more of the tasks in which the tasks are to be performed according to a sequence or an order.

These and other examples of timing considerations or characteristics associated with the tasks present challenges for meeting timeline considerations associated with provisioning a software instance. If these different tasks are not performed until after the user requests provisioning, it becomes extremely difficult to complete these tasks by the time that a user may access the software instance. Such delays may adversely affect user experience. For example, a user may notice that after accessing the software instance, some user interface components may be incomplete or missing. Further, as increased quantities of settings and metadata deployment features and corresponding tasks are made available, timeline considerations become much more difficult.

As such, the provisioning procedure 212 may be divided into the first phase 215 and the second phase 220. The first phase 215 may be referred to as a replenish mode or replenish phase and the second phase 220 may be referred to as an allocation mode or allocation phase. In each phase, the server 210 may identify, select, configure, assign, or determine a set of the tasks (e.g., relating to configurations, metadata, or other tasks for provisioning software instances), run the tasks on a software instance of the software instance pool 240 that may be requested for provisioning, or both.

In some examples, it may be desirable to move multiple tasks into the first phase 215 as opposed to the second phase 220 to reduce provisioning time since the first phase 215 may be performed before the user requests provisioning. In this way, the software instance may be prepared and waiting in the software instance pool 240 before the user signup process begins. For example, the server 210 may identify, assign, select, or determine that the first tasks 225 are to be performed in the first phase 215 and that the second tasks 230 are to be performed in the second phase 220. The first tasks 225 may be performed before the user requests provisioning, thereby reducing the quantity of second tasks 230 that are to be performed.

For example, the server 210 may identify the first tasks 225 and the second tasks 230 and that the first tasks 225 are to be performed in the first phase 215 and that the second tasks 230 are to be performed in the second phase 220. The server 210 may run the first tasks 225 (e.g., as part of the first phase 215) on a software instance in the software instance pool 240 (e.g., to prepare the software instance for subsequent provisioning actions, such as the second phase 220). The server 210 may receive the provisioning request 235 from the client 205 and the server 210 may then run the second tasks 230 (e.g., as part of the second phase 220). These second tasks 230 may be specific to the user or may not otherwise be able to be performed before receiving the provisioning request 235. The server 210 may make the provisioned software instance available to the user (e.g., via the client 205). In this way, the provisioning process may be performed more quickly and with less delay for the user while still ensuring that features and information for proper operation of the software instance are prepared and ready for use by the user.

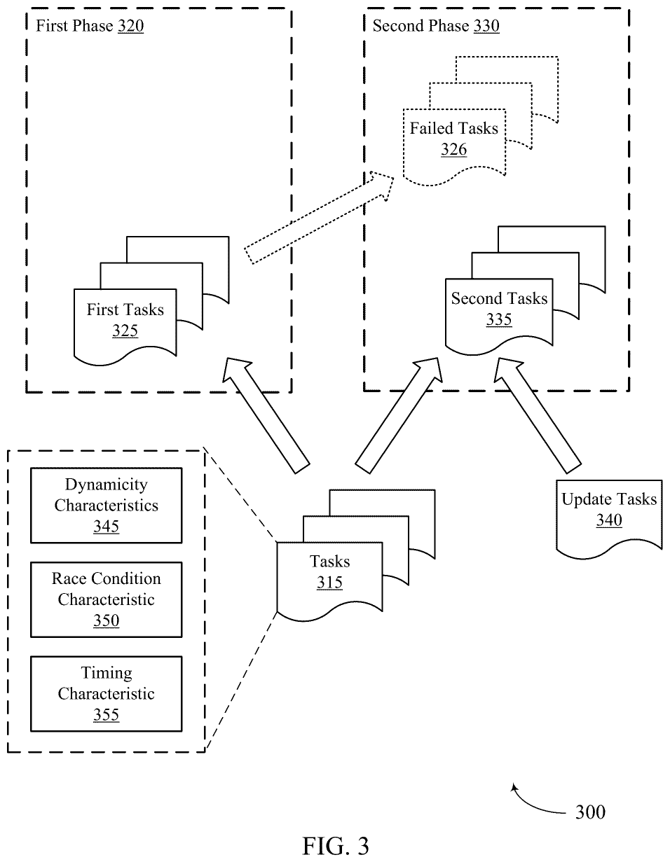

FIG. 3 illustrates an example of a provisioning scheme 300 that supports multi-phase provisioning in accordance with examples as disclosed herein. The provisioning scheme 300 may include the first phase 320, the second phase 330, the tasks 315 that may be assigned as the first tasks 325 and the second tasks 335 according to techniques described herein.

The provisioning procedure may include the first phase 320 and the second phase 330. In the first phase 320, the first tasks 325 may be performed. The first tasks 325 may be tasks that may be performed earlier in the provisioning procedure (e.g., before a user signs up or requests provisioning of a software instance). In the first phase 320 (also referred to as a replenish phase or replenish mode), the software instances (e.g., those in a software instance pool) may be in a pre-sign up or pre-provisioning state. During or before the first phase 320, the software instances may be replenished or created in a software instance pool. In some examples, a software instance in the software instance pool may be associated with an identifier that may be associated with a template for the software instance. In some examples, the software instance pool may be managed to ensure that a quantity of software instances may be present in the pool and ready to be provisioned according to the techniques described herein. In some examples, a database system or cloud platform may ensure that a quantity of software instances for one or more provisioning templates may be present in the pool and ready to be provisioned.

In some examples, the first tasks 325 may include tasks that are associated with manageable settings, manageable metadata deployments, or both. For example, such manageable tasks may be tasks associated with settings that are static, tasks that are not associated with a provisioning race condition (e.g., such as some API calls), tasks that are associated with static settings that are not intended to change over time or are intended to change a quantity of times that satisfies a threshold. In this way, the software instances that have performed the first tasks 325 may be more widely applicable to a variety of users and not only to specific users.

The provisioning procedure may include the second phase 330, also referred to as an allocation phase. In the second phase 330, software instances may be in a trial stage or may be in the process of being assigned to a user (e.g., based on a provisioning request received from a user or a client). In some examples, the software instance may be assigned to the user based on a template included in or associated with the software instance or based on one or more of the first tasks 325 performed on or by the software instance. In the second phase 330, some or all of the second tasks 335 may be time-sensitive tasks as the user may be accessing the requested software instance. In some examples, such software instances may support parallelism approaches, task retries, task dependencies, or any combination thereof. In some examples, tasks that were performed successfully (e.g., as part of the first tasks 325) may not be performed in the second phase 330.

In some examples, the second tasks 335 may include one or more non-manageable tasks. Such non-manageable tasks may be tasks that are dynamic (e.g., subject to or associated with regular updates or changes such as from a cloud-based control plane, a SaaS deployment architecture, or the like), tasks that are associated with a provisioning race condition, tasks that may change depending on a user selection or preference (e.g., as expressed in the provisioning request), or any combination thereof. For example, as some implementations of the subject matter described herein may include operations involving software as a service (Saas), updates (e.g., regular or irregular updates) may be made to improve the SaaS implementation. Such updates may include customer- or user-facing updates, or may include internal updates that may not be apparent to the user. Such updates may be performed at any time, including even after the user has accessed a software instance. At least because these updates may be different for different users, software instances, or SaaS implementations, they are better suited for performance in the second tasks 335 (e.g., as opposed to the first tasks 325) because the first tasks 325 may be more widely applicable (e.g., because some software instances may have already received an update, whereas others may not have received such an update).

In some examples, the tasks 315 may include a set of tasks that are to be performed to properly provision a software instance. Individual tasks 315 may be assigned to the first phase 320 or the second phase 330 based on one or more factors. For example, some tasks deemed to be of higher importance may be assigned to the first phase 320 as first tasks 325. Such first tasks 325 may include tasks that are to be performed at an earlier stage in the provisioning procedure. For example, such first tasks 325 may include tasks associated with basic or prioritized settings, metadata, account information, contact information, or any combination thereof.

However, other individual tasks 315 may be assigned to the second phase 330 based on one or more factors. Individual tasks 315 deemed to be of lesser importance may be assigned to the second phase 330 as second tasks 335. For example, such second tasks 335 may include tasks that may be completed in a later stage of the provisioning process, user-specific configurations or metadata, geolocation information, organization- or group-specific configurations or metadata, or any combination thereof.

In some examples, the tasks 315 may include one or more characteristics that may influence whether a task 315 is assigned as a first task 325 in the first phase 320 or as a second task 335 in the second phase 330. For example, such characteristics may include dynamicity characteristics 345 that may describe whether a task 315 is dynamic or static or may describe how dynamic or how static a task 315 may be on a dynamicity spectrum. Such characteristics may further include a race condition characteristic 350 that may indicate whether or not the task 315 is subject to a race condition or an order or sequence for performing one or more tasks. Such characteristics may further include a timing characteristic 355 that may indicate a time or event by which the task 315 is to be started or finished (e.g., a time at which a user requests provisioning or a time at which a user accesses the software instance).

In some examples, a database system or cloud platform may determine that a task 315 may include one or more sub-tasks that may have differing characteristics (e.g., such as characteristics similar to those described in relation to the first phase 320, the first tasks 325, the second phase 330, the second tasks 335, or any combination thereof). The database system or cloud platform may split a task 315 into the sub-tasks and may assign the sub-tasks to the first phase 320 as first tasks 325, to the second phase 330 as second tasks 335, or both.

In some examples, a first task 325 may fail or produce one or more errors when the task is run as part of the first phase 320. In such a case, such a failed task 326 may be performed or attempted again as part of the second phase 330. In this way, completeness and integrity of a provisioned software instance may be improved since a failed task may be performed again.

In some examples, one or more update tasks 340 may be performed to update one or more aspects of a software instance. In some examples, the update tasks 340 may be considered to be second tasks 335. Such updates may include updates to layouts, configurations, metadata, or other information associated with the software instances and may be performed on a regular basis. Because such updates are by their nature dynamic, they are better suited to be performed in the second phase 330 that is performed after receiving the provisioning request (e.g., instead of the first phase 320 in which configurations, settings, or metadata that are static or remain relatively unchanged are “pre-baked” into sets of software instances).

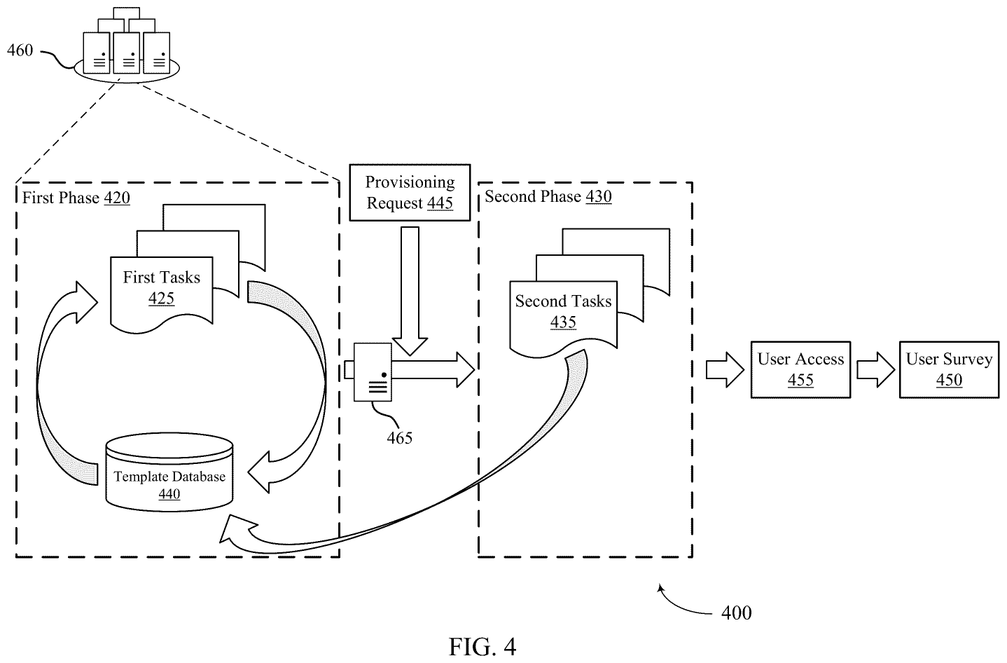

FIG. 4 illustrates an example of a provisioning scheme 400 that supports multi-phase provisioning in accordance with examples as disclosed herein. The provisioning scheme 400 may include the first phase 420 during which one or more first tasks 425 may be performed and the second phase 430 during which one or more second tasks 435 may be performed, after which the user may access the provisioned compute instances during the user access 455. The software instance 465 may be selected from the software instance pool 460 or assigned to the user based on the provisioning request 445.

In some examples, one or more templates indicating one or more first tasks 425 may be stored in the template database 440. Because the first tasks 425 may be more generally-applicable or static, such first tasks 425 may be used to “pre-bake” software instances with sets of configurations, settings, metadata, or any combination thereof that may later be further configured or adjusted after receiving the provisioning request 445 with user-specific information or configurations.

Similarly, the templates themselves may be updated to include one or more first tasks 425, one or more second tasks 435, or both. In some examples, an analysis of provisioned software instances may be performed to determine one or more tasks (e.g., one or more first tasks 425, one or more second tasks 435, or both) that may have been used in at least a threshold quantity of provisioned software instances or based on one or more other factors. Such templates may be applied to one or more compute instances of the software instance pool 460.

In some examples, a user may fill out a user survey 450 that may indicate information about features, configurations, settings, or information associated with one or more software instances that may be processed in the first tasks 425, the second tasks 435, or both. Such information may be analyzed by the database system or cloud platform and may be a factor for determining, selecting, or assigning the first tasks 425, the second tasks 435, or both. Additionally, or alternatively, such information may be used to modify the first tasks 425, the second tasks 435, or both. Such a user survey 450 may provide an opportunity to perform one or more tasks of the first tasks 425, the second tasks 435, or both, that failed during the first phase 420, the second phase 430, or both. Further, the user survey 450 may indicate one or more features or configurations that the user desires to implement in the software instance. In some examples, such features or configurations may be implemented in the software instance based on the user survey 450 or one or more indications included therein.

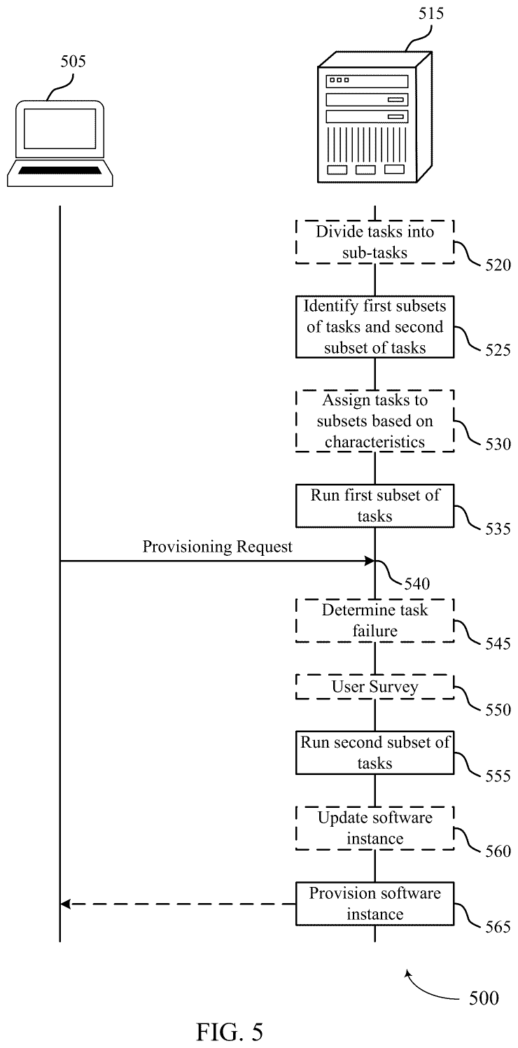

FIG. 5 illustrates an example of a process flow 500 that supports multi-phase provisioning in accordance with examples as disclosed herein. The process flow 500 may implement various aspects of the present disclosure described herein. The elements described in the process flow: 500 (e.g., the user device 505, the application server 515, or both) may be examples of similarly-named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the application server 515 may divide a first provisioning task into a first provisioning subtask and a second provisioning subtask based on one or more dynamicity characteristics of the first provisioning task, a presence or lack of a race condition associated with the first provisioning task, or both.

At 525, the application server 515 may identify a first subset of provisioning tasks associated with a first phase of the multi-phase provisioning procedure and a second subset of provisioning tasks associated with a second phase of the multi-phase provisioning procedure. In some examples, the plurality of provisioning tasks comprise one or more software instance setting configuration tasks, one or more software instance layout tasks, one or more software instance metadata tasks, or any combination thereof.

At 530, the application server 515 may assign individual provisioning tasks to the first subset of provisioning tasks or the second subset of provisioning tasks based on one or more dynamicity characteristics of the individual provisioning tasks, a presence or lack of a race condition associated with the individual provisioning tasks, one or more timing parameters associated with the individual provisioning tasks, or any combination thereof. In some examples, the application server 515 may assign the first provisioning subtask to the first subset of provisioning tasks and assign the second provisioning subtask to the second subset of provisioning tasks, optionally based on the one or more dynamicity characteristics of the first provisioning task, a presence or lack of a race condition associated with the first provisioning task, or both.

At 535, the application server 515 may run the first subset of provisioning tasks on a plurality of software instances of a pool of software instances prior to a provisioning request for the software instance. In some examples, the application server 515 may run the first subset of provisioning tasks based on one or more provisioning templates stored in a provisioning template database. In some examples, the application server 515 may store an indication of the first subset of provisioning tasks in an additional provisioning template in the provisioning template database based on running the first subset of provisioning tasks and determining that the first subset of tasks is not included in any of the one or more provisioning templates.

At 540, the application server 515 may receive, from a user device 505, the provisioning request.

At 545, the application server 515 may determine that a first attempt to run a first provisioning task of the first subset of provisioning tasks has failed or was not performed. The application server 515 may assign the first provisioning task to the second subset of provisioning tasks.

At 550, the application server 515 may receive a user survey report indicating one or more configuration preferences associated with the second subset of provisioning tasks.

At 555, the application server 515 may run, based on the provisioning request and on the software instance from the pool of software instances, the second subset of provisioning tasks and the second subset of provisioning tasks are specific to the user. In some examples, the second subset of provisioning tasks may include a second attempt to run the first provisioning task. In some examples, the second subset of provisioning tasks is run based on the user survey report.

At 560, the application server 515 may update one or more aspects of the software instance associated with the second subset of provisioning tasks based on receiving an update command.

At 565, the application server 515 may provision the software instance to the user.

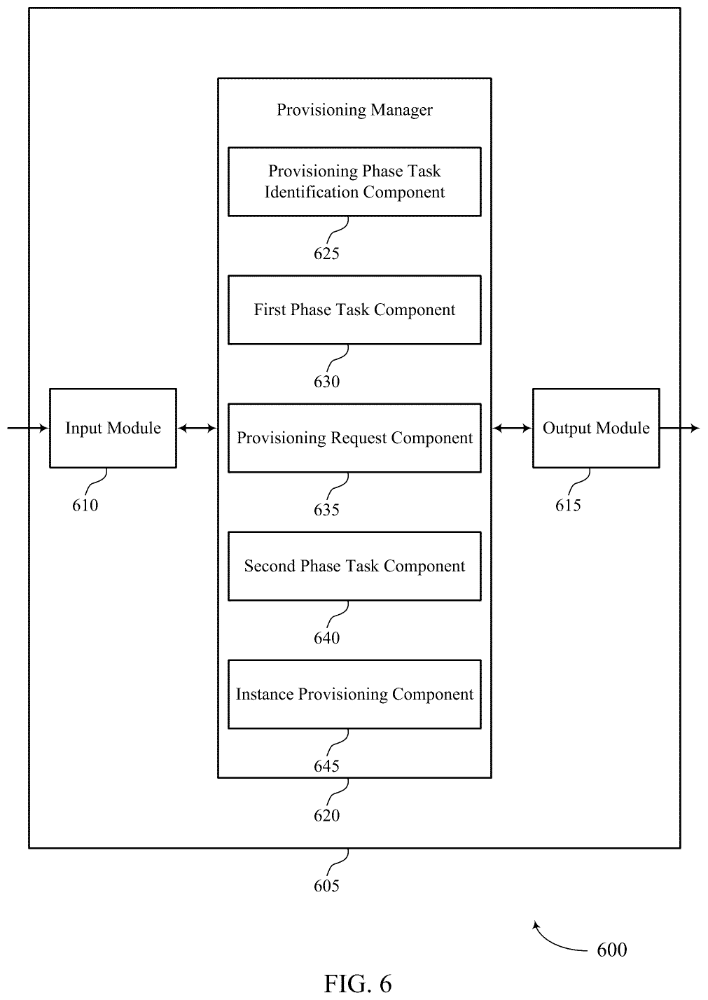

FIG. 6 illustrates a block diagram 600 of a device 605 that supports multi-phase provisioning in accordance with examples as disclosed herein. The device 605 may include an input module 610, an output module 615, and a provisioning manager 620. The device 605 may also include a processor. Each of these components may be in communication with one another (e.g., via one or more buses).

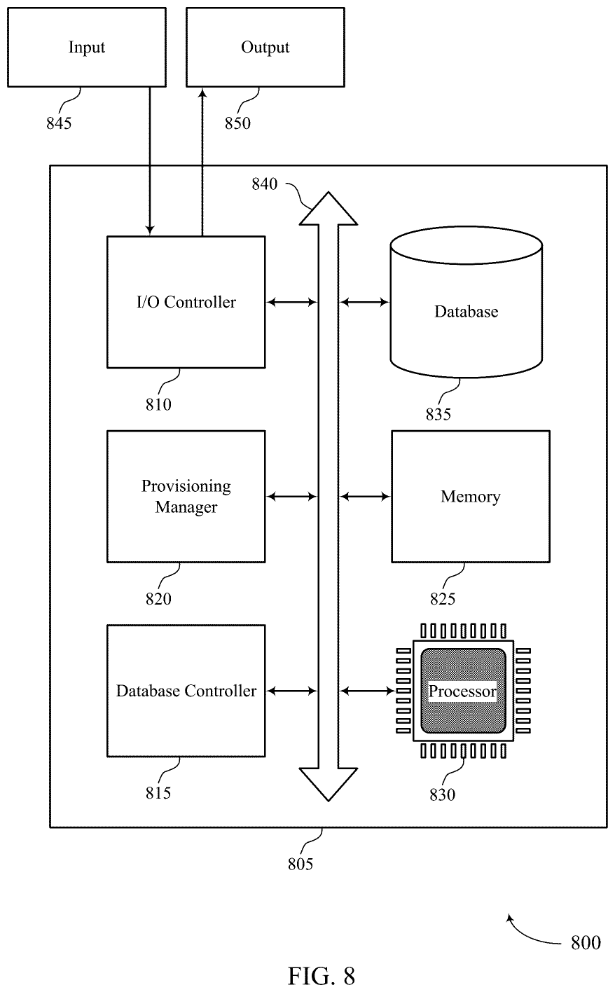

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the provisioning manager 620 to support multi-phase provisioning. In some cases, the input module 610 may be a component of an I/O controller 810 as described with reference to FIG. 8.

The output module 615 may manage output signals for the device 605. For example, the output module 615 may receive signals from other components of the device 605, such as the provisioning manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the provisioning manager 620 may include a provisioning phase task identification component 625, a first phase task component 630, a provisioning request component 635, a second phase task component 640, an instance provisioning component 645, or any combination thereof. In some examples, the provisioning manager 620, or various components thereof, may be configured to perform various operations (e.g., receiving, monitoring, transmitting) using or otherwise in cooperation with the input module 610, the output module 615, or both. For example, the provisioning manager 620 may receive information from the input module 610, send information to the output module 615, or be integrated in combination with the input module 610, the output module 615, or both to receive information, transmit information, or perform various other operations as described herein.

The provisioning manager 620 may support instantiating a software instance in a multi-phase provisioning procedure including a set of multiple provisioning tasks in accordance with examples as disclosed herein. The provisioning phase task identification component 625 may be configured to support identifying a first subset of provisioning tasks associated with a first phase of the multi-phase provisioning procedure and a second subset of provisioning tasks associated with a second phase of the multi-phase provisioning procedure. The first phase task component 630 may be configured to support running the first subset of provisioning tasks on a set of multiple software instances of a pool of software instances prior to a provisioning request for the software instance. The provisioning request component 635 may be configured to support receiving, from a user, the provisioning request. The second phase task component 640 may be configured to support running, based on the provisioning request and on the software instance from the pool of software instances, the second subset of provisioning tasks, where the second subset of provisioning tasks are specific to the user. The instance provisioning component 645 may be configured to support provisioning the software instance to the user.

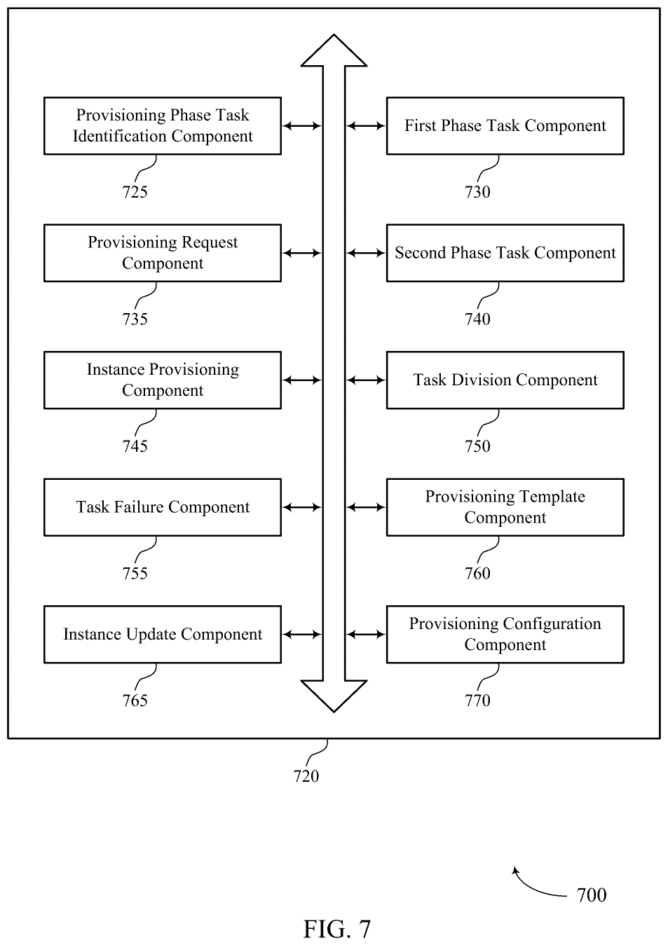

FIG. 7 illustrates a block diagram 700 of a provisioning manager 720 that supports multi-phase provisioning in accordance with examples as disclosed herein. The provisioning manager 720 may be an example of aspects of a provisioning manager or a provisioning manager 620, or both, as described herein. The provisioning manager 720, or various components thereof, may be an example of means for performing various aspects of multi-phase provisioning as described herein. For example, the provisioning manager 720 may include a provisioning phase task identification component 725, a first phase task component 730, a provisioning request component 735, a second phase task component 740, an instance provisioning component 745, a task division component 750, a task failure component 755, a provisioning template component 760, an instance update component 765, a provisioning configuration component 770, or any combination thereof. Each of these components may communicate, directly or indirectly, with one another (e.g., via one or more buses).

The provisioning manager 720 may support instantiating a software instance in a multi-phase provisioning procedure including a set of multiple provisioning tasks in accordance with examples as disclosed herein. The provisioning phase task identification component 725 may be configured to support identifying a first subset of provisioning tasks associated with a first phase of the multi-phase provisioning procedure and a second subset of provisioning tasks associated with a second phase of the multi-phase provisioning procedure. The first phase task component 730 may be configured to support running the first subset of provisioning tasks on a set of multiple software instances of a pool of software instances prior to a provisioning request for the software instance. The provisioning request component 735 may be configured to support receiving, from a user, the provisioning request. The second phase task component 740 may be configured to support running, based on the provisioning request and on the software instance from the pool of software instances, the second subset of provisioning tasks, where the second subset of provisioning tasks are specific to the user. The instance provisioning component 745 may be configured to support provisioning the software instance to the user.

In some examples, the provisioning phase task identification component 725 may be configured to support assigning individual provisioning tasks to the first subset of provisioning tasks or the second subset of provisioning tasks based on one or more dynamicity characteristics of the individual provisioning tasks, a presence or lack of a race condition associated with the individual provisioning tasks, one or more timing parameters associated with the individual provisioning tasks, or any combination thereof.

In some examples, the task division component 750 may be configured to support dividing a first provisioning task into a first provisioning subtask and a second provisioning subtask based on one or more dynamicity characteristics of the first provisioning task, a presence or lack of a race condition associated with the first provisioning task, or both. In some examples, the provisioning phase task identification component 725 may be configured to support assigning the first provisioning subtask to the first subset of provisioning tasks. In some examples, the provisioning phase task identification component 725 may be configured to support assigning the second provisioning subtask to the second subset of provisioning tasks.

In some examples, the task failure component 755 may be configured to support determining that a first attempt to run a first provisioning task of the first subset of provisioning tasks has failed or was not performed. In some examples, the provisioning phase task identification component 725 may be configured to support assigning the first provisioning task to the second subset of provisioning tasks. In some examples, the second phase task component 740 may be configured to support where running the second subset of provisioning tasks includes running a second attempt to run the first provisioning task.

In some examples, the provisioning template component 760 may be configured to support running the first subset of provisioning tasks based on one or more provisioning templates stored in a provisioning template database.

In some examples, the provisioning template component 760 may be configured to support storing an indication of the first subset of provisioning tasks in an additional provisioning template in the provisioning template database based on running the first subset of provisioning tasks and determining that the first subset of tasks is not included in any of the one or more provisioning templates.

In some examples, the instance update component 765 may be configured to support updating one or more aspects of the software instance associated with the second subset of provisioning tasks based on receiving an update command.

In some examples, the set of multiple provisioning tasks include one or more software instance setting configuration tasks, one or more software instance layout tasks, one or more software instance metadata tasks, or any combination thereof.

In some examples, the provisioning configuration component 770 may be configured to support receiving a user survey report indicating one or more configuration preferences associated with the second subset of provisioning tasks, where running the second subset of provisioning tasks is based on the user survey report.

FIG. 8 illustrates a diagram of a system 800 including a device 805 that supports multi-phase provisioning in accordance with examples as disclosed herein. The device 805 may be an example of or include the components of a device 605 as described herein. The device 805 may include components for bi-directional data communications including components for transmitting and receiving communications, such as a provisioning manager 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and ROM. The memory 825 may store computer-readable, computer-executable software including instructions that, when executed, cause the processor 830 to perform various functions described herein. In some cases, the memory 825 may contain, among other things, a BIOS which may control basic hardware or software operation such as the interaction with peripheral components or devices.

The processor 830 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting multi-phase provisioning).

The provisioning manager 820 may support instantiating a software instance in a multi-phase provisioning procedure including a set of multiple provisioning tasks in accordance with examples as disclosed herein. For example, the provisioning manager 820 may be configured to support identifying a first subset of provisioning tasks associated with a first phase of the multi-phase provisioning procedure and a second subset of provisioning tasks associated with a second phase of the multi-phase provisioning procedure. The provisioning manager 820 may be configured to support running the first subset of provisioning tasks on a set of multiple software instances of a pool of software instances prior to a provisioning request for the software instance. The provisioning manager 820 may be configured to support receiving, from a user, the provisioning request. The provisioning manager 820 may be configured to support running, based on the provisioning request and on the software instance from the pool of software instances, the second subset of provisioning tasks, where the second subset of provisioning tasks are specific to the user. The provisioning manager 820 may be configured to support provisioning the software instance to the user.

By including or configuring the provisioning manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

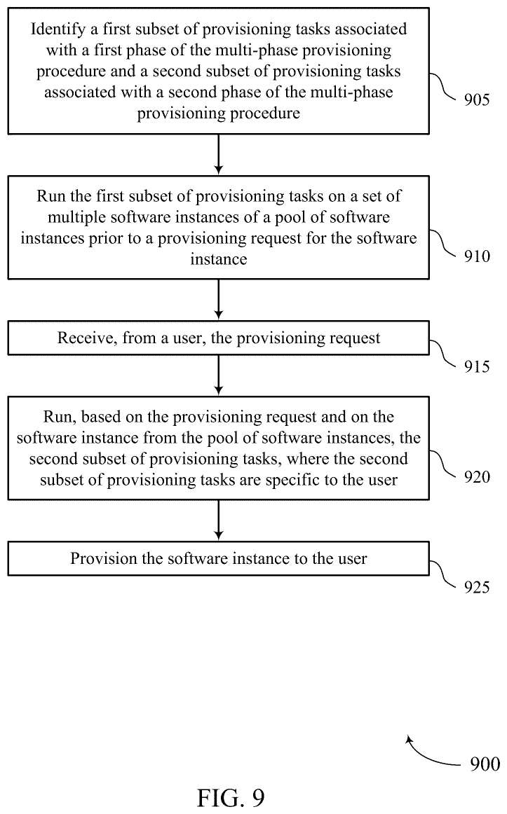

FIG. 9 illustrates a flowchart showing a method 900 that supports multi-phase provisioning in accordance with examples as disclosed herein. The operations of the method 900 may be implemented by an application server or its components as described herein. For example, the operations of the method 900 may be performed by an application server as described with reference to FIGS. 1 through 8. In some examples, an application server may execute a set of instructions to control the functional elements of the application server to perform the described functions. Additionally, or alternatively, the application server may perform aspects of the described functions using special-purpose hardware.

At 905, the method may include identifying a first subset of provisioning tasks associated with a first phase of the multi-phase provisioning procedure and a second subset of provisioning tasks associated with a second phase of the multi-phase provisioning procedure. The operations of 905 may be performed in accordance with examples as disclosed herein. In some examples, aspects of the operations of 905 may be performed by a provisioning phase task identification component 725 as described with reference to FIG. 7.

At 910, the method may include running the first subset of provisioning tasks on a set of multiple software instances of a pool of software instances prior to a provisioning request for the software instance. The operations of 910 may be performed in accordance with examples as disclosed herein. In some examples, aspects of the operations of 910 may be performed by a first phase task component 730 as described with reference to FIG. 7.

At 915, the method may include receiving, from a user, the provisioning request. The operations of 915 may be performed in accordance with examples as disclosed herein. In some examples, aspects of the operations of 915 may be performed by a provisioning request component 735 as described with reference to FIG. 7.

At 920, the method may include running, based on the provisioning request and on the software instance from the pool of software instances, the second subset of provisioning tasks, where the second subset of provisioning tasks are specific to the user. The operations of 920 may be performed in accordance with examples as disclosed herein. In some examples, aspects of the operations of 920 may be performed by a second phase task component 740 as described with reference to FIG. 7.

At 925, the method may include provisioning the software instance to the user. The operations of 925 may be performed in accordance with examples as disclosed herein. In some examples, aspects of the operations of 925 may be performed by an instance provisioning component 745 as described with reference to FIG. 7.

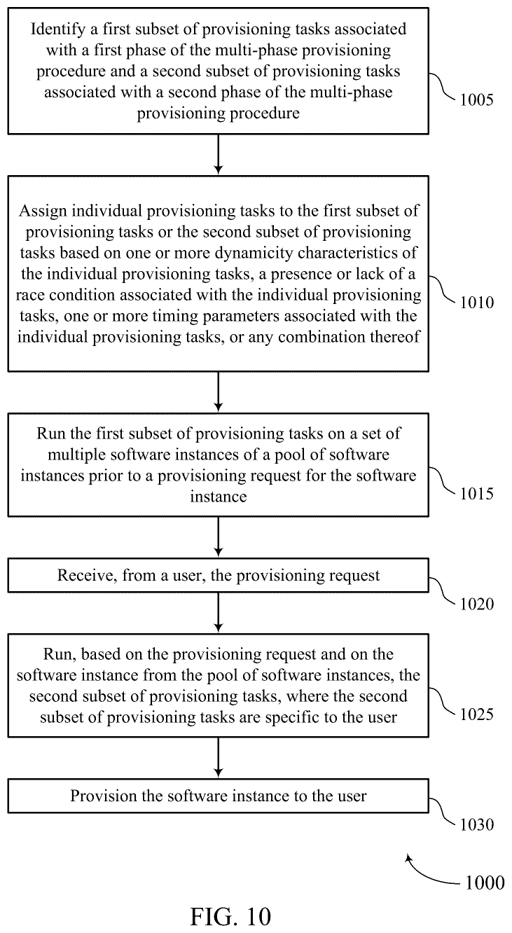

FIG. 10 illustrates a flowchart showing a method 1000 that supports multi-phase provisioning in accordance with examples as disclosed herein. The operations of the method 1000 may be implemented by an application server or its components as described herein. For example, the operations of the method 1000 may be performed by an application server as described with reference to FIGS. 1 through 8. In some examples, an application server may execute a set of instructions to control the functional elements of the application server to perform the described functions. Additionally, or alternatively, the application server may perform aspects of the described functions using special-purpose hardware.

At 1005, the method may include identifying a first subset of provisioning tasks associated with a first phase of the multi-phase provisioning procedure and a second subset of provisioning tasks associated with a second phase of the multi-phase provisioning procedure. The operations of 1005 may be performed in accordance with examples as disclosed herein. In some examples, aspects of the operations of 1005 may be performed by a provisioning phase task identification component 725 as described with reference to FIG. 7.

At 1010, the method may include assigning individual provisioning tasks to the first subset of provisioning tasks or the second subset of provisioning tasks based on one or more dynamicity characteristics of the individual provisioning tasks, a presence or lack of a race condition associated with the individual provisioning tasks, one or more timing parameters associated with the individual provisioning tasks, or any combination thereof. The operations of 1010 may be performed in accordance with examples as disclosed herein. In some examples, aspects of the operations of 1010 may be performed by a provisioning phase task identification component 725 as described with reference to FIG. 7.

At 1015, the method may include running the first subset of provisioning tasks on a set of multiple software instances of a pool of software instances prior to a provisioning request for the software instance. The operations of 1015 may be performed in accordance with examples as disclosed herein. In some examples, aspects of the operations of 1015 may be performed by a first phase task component 730 as described with reference to FIG. 7.

At 1020, the method may include receiving, from a user, the provisioning request. The operations of 1020 may be performed in accordance with examples as disclosed herein. In some examples, aspects of the operations of 1020 may be performed by a provisioning request component 735 as described with reference to FIG. 7.

At 1025, the method may include running, based on the provisioning request and on the software instance from the pool of software instances, the second subset of provisioning tasks, where the second subset of provisioning tasks are specific to the user. The operations of 1025 may be performed in accordance with examples as disclosed herein. In some examples, aspects of the operations of 1025 may be performed by a second phase task component 740 as described with reference to FIG. 7.

At 1030, the method may include provisioning the software instance to the user. The operations of 1030 may be performed in accordance with examples as disclosed herein. In some examples, aspects of the operations of 1030 may be performed by an instance provisioning component 745 as described with reference to FIG. 7.

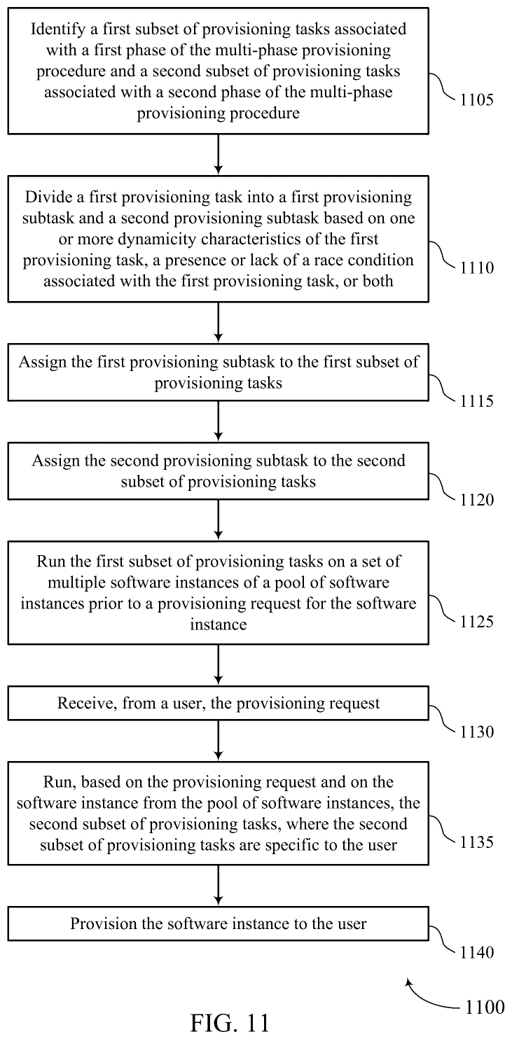

FIG. 11 illustrates a flowchart showing a method 1100 that supports multi-phase provisioning in accordance with examples as disclosed herein. The operations of the method 1100 may be implemented by an application server or its components as described herein. For example, the operations of the method 1100 may be performed by an application server as described with reference to FIGS. 1 through 8. In some examples, an application server may execute a set of instructions to control the functional elements of the application server to perform the described functions. Additionally, or alternatively, the application server may perform aspects of the described functions using special-purpose hardware.

At 1105, the method may include identifying a first subset of provisioning tasks associated with a first phase of the multi-phase provisioning procedure and a second subset of provisioning tasks associated with a second phase of the multi-phase provisioning procedure. The operations of 1105 may be performed in accordance with examples as disclosed herein. In some examples, aspects of the operations of 1105 may be performed by a provisioning phase task identification component 725 as described with reference to FIG. 7.

At 1110, the method may include dividing a first provisioning task into a first provisioning subtask and a second provisioning subtask based on one or more dynamicity characteristics of the first provisioning task, a presence or lack of a race condition associated with the first provisioning task, or both. The operations of 1110 may be performed in accordance with examples as disclosed herein. In some examples, aspects of the operations of 1110 may be performed by a task division component 750 as described with reference to FIG. 7.

At 1115, the method may include assigning the first provisioning subtask to the first subset of provisioning tasks. The operations of 1115 may be performed in accordance with examples as disclosed herein. In some examples, aspects of the operations of 1115 may be performed by a provisioning phase task identification component 725 as described with reference to FIG. 7.

At 1120, the method may include assigning the second provisioning subtask to the second subset of provisioning tasks. The operations of 1120 may be performed in accordance with examples as disclosed herein. In some examples, aspects of the operations of 1120 may be performed by a provisioning phase task identification component 725 as described with reference to FIG. 7.

At 1125, the method may include running the first subset of provisioning tasks on a set of multiple software instances of a pool of software instances prior to a provisioning request for the software instance. The operations of 1125 may be performed in accordance with examples as disclosed herein. In some examples, aspects of the operations of 1125 may be performed by a first phase task component 730 as described with reference to FIG. 7.

At 1130, the method may include receiving, from a user, the provisioning request. The operations of 1130 may be performed in accordance with examples as disclosed herein. In some examples, aspects of the operations of 1130 may be performed by a provisioning request component 735 as described with reference to FIG. 7.

At 1135, the method may include running, based on the provisioning request and on the software instance from the pool of software instances, the second subset of provisioning tasks, where the second subset of provisioning tasks are specific to the user. The operations of 1135 may be performed in accordance with examples as disclosed herein. In some examples, aspects of the operations of 1135 may be performed by a second phase task component 740 as described with reference to FIG. 7.

At 1140, the method may include provisioning the software instance to the user. The operations of 1140 may be performed in accordance with examples as disclosed herein. In some examples, aspects of the operations of 1140 may be performed by an instance provisioning component 745 as described with reference to FIG. 7.

A method for instantiating a software instance in a multi-phase provisioning procedure including a set of multiple provisioning tasks is described. The method may include identifying a first subset of provisioning tasks associated with a first phase of the multi-phase provisioning procedure and a second subset of provisioning tasks associated with a second phase of the multi-phase provisioning procedure, running the first subset of provisioning tasks on a set of multiple software instances of a pool of software instances prior to a provisioning request for the software instance, receiving, from a user, the provisioning request, running, based on the provisioning request and on the software instance from the pool of software instances, the second subset of provisioning tasks, where the second subset of provisioning tasks are specific to the user, and provisioning the software instance to the user.

An apparatus for instantiating a software instance in a multi-phase provisioning procedure including a set of multiple provisioning tasks is described. The apparatus may include a processor, memory coupled with the processor, and instructions stored in the memory. The instructions may be executable by the processor to cause the apparatus to identify a first subset of provisioning tasks associated with a first phase of the multi-phase provisioning procedure and a second subset of provisioning tasks associated with a second phase of the multi-phase provisioning procedure, run the first subset of provisioning tasks on a set of multiple software instances of a pool of software instances prior to a provisioning request for the software instance, receive, from a user, the provisioning request, run, based on the provisioning request and on the software instance from the pool of software instances, the second subset of provisioning tasks, where the second subset of provisioning tasks are specific to the user, and provision the software instance to the user.

Another apparatus for instantiating a software instance in a multi-phase provisioning procedure including a set of multiple provisioning tasks is described. The apparatus may include means for identifying a first subset of provisioning tasks associated with a first phase of the multi-phase provisioning procedure and a second subset of provisioning tasks associated with a second phase of the multi-phase provisioning procedure, means for running the first subset of provisioning tasks on a set of multiple software instances of a pool of software instances prior to a provisioning request for the software instance, means for receiving, from a user, the provisioning request, means for running, based on the provisioning request and on the software instance from the pool of software instances, the second subset of provisioning tasks, where the second subset of provisioning tasks are specific to the user, and means for provisioning the software instance to the user.

A non-transitory computer-readable medium storing code for instantiating a software instance in a multi-phase provisioning procedure including a set of multiple provisioning tasks is described. The code may include instructions executable by a processor to identify a first subset of provisioning tasks associated with a first phase of the multi-phase provisioning procedure and a second subset of provisioning tasks associated with a second phase of the multi-phase provisioning procedure, run the first subset of provisioning tasks on a set of multiple software instances of a pool of software instances prior to a provisioning request for the software instance, receive, from a user, the provisioning request, run, based on the provisioning request and on the software instance from the pool of software instances, the second subset of provisioning tasks, where the second subset of provisioning tasks are specific to the user, and provision the software instance to the user.

Some examples of the method, apparatuses, and non-transitory computer-readable medium described herein may further include operations, features, means, or instructions for assigning individual provisioning tasks to the first subset of provisioning tasks or the second subset of provisioning tasks based on one or more dynamicity characteristics of the individual provisioning tasks, a presence or lack of a race condition associated with the individual provisioning tasks, one or more timing parameters associated with the individual provisioning tasks, or any combination thereof.

Some examples of the method, apparatuses, and non-transitory computer-readable medium described herein may further include operations, features, means, or instructions for dividing a first provisioning task into a first provisioning subtask and a second provisioning subtask based on one or more dynamicity characteristics of the first provisioning task, a presence or lack of a race condition associated with the first provisioning task, or both, assigning the first provisioning subtask to the first subset of provisioning tasks, and assigning the second provisioning subtask to the second subset of provisioning tasks.

Some examples of the method, apparatuses, and non-transitory computer-readable medium described herein may further include operations, features, means, or instructions for determining that a first attempt to run a first provisioning task of the first subset of provisioning tasks may have failed or was not performed, assigning the first provisioning task to the second subset of provisioning tasks, and where running the second subset of provisioning tasks includes running a second attempt to run the first provisioning task.

Some examples of the method, apparatuses, and non-transitory computer-readable medium described herein may further include operations, features, means, or instructions for running the first subset of provisioning tasks based on one or more provisioning templates stored in a provisioning template database.

Some examples of the method, apparatuses, and non-transitory computer-readable medium described herein may further include operations, features, means, or instructions for storing an indication of the first subset of provisioning tasks in an additional provisioning template in the provisioning template database based on running the first subset of provisioning tasks and determining that the first subset of tasks may be not included in any of the one or more provisioning templates.

Some examples of the method, apparatuses, and non-transitory computer-readable medium described herein may further include operations, features, means, or instructions for updating one or more aspects of the software instance associated with the second subset of provisioning tasks based on receiving an update command.

In some examples of the method, apparatuses, and non-transitory computer-readable medium described herein, the set of multiple provisioning tasks include one or more software instance setting configuration tasks, one or more software instance layout tasks, one or more software instance metadata tasks, or any combination thereof.

Some examples of the method, apparatuses, and non-transitory computer-readable medium described herein may further include operations, features, means, or instructions for receiving a user survey report indicating one or more configuration preferences associated with the second subset of provisioning tasks, where running the second subset of provisioning tasks may be based on the user survey report.

The following provides an overview of aspects of the present disclosure:
Aspect 1: A method for instantiating a software instance in a multi-phase provisioning procedure comprising a plurality of provisioning tasks, comprising: identifying a first subset of provisioning tasks associated with a first phase of the multi-phase provisioning procedure and a second subset of provisioning tasks associated with a second phase of the multi-phase provisioning procedure: running the first subset of provisioning tasks on a plurality of software instances of a pool of software instances prior to a provisioning request for the software instance: receiving, from a user, the provisioning request: running, based at least in part on the provisioning request and on the software instance from the pool of software instances, the second subset of provisioning tasks, wherein the second subset of provisioning tasks are specific to the user; and provisioning the software instance to the user.
Aspect 2: The method of aspect 1, further comprising: assigning individual provisioning tasks to the first subset of provisioning tasks or the second subset of provisioning tasks based at least in part on one or more dynamicity characteristics of the individual provisioning tasks, a presence or lack of a race condition associated with the individual provisioning tasks, one or more timing parameters associated with the individual provisioning tasks, or any combination thereof.
Aspect 3: The method of any of aspects 1 through 2, further comprising: dividing a first provisioning task into a first provisioning subtask and a second provisioning subtask based at least in part on one or more dynamicity characteristics of the first provisioning task, a presence or lack of a race condition associated with the first provisioning task, or both; assigning the first provisioning subtask to the first subset of provisioning tasks; and assigning the second provisioning subtask to the second subset of provisioning tasks.
Aspect 4: The method of any of aspects 1 through 3, further comprising: determining that a first attempt to run a first provisioning task of the first subset of provisioning tasks has failed or was not performed; and assigning the first provisioning task to the second subset of provisioning tasks: wherein running the second subset of provisioning tasks comprises running a second attempt to run the first provisioning task.
Aspect 5: The method of any of aspects 1 through 4, further comprising: running the first subset of provisioning tasks based at least in part on one or more provisioning templates stored in a provisioning template database.
Aspect 6: The method of aspect 5, further comprising: storing an indication of the first subset of provisioning tasks in an additional provisioning template in the provisioning template database based at least in part on running the first subset of provisioning tasks and determining that the first subset of tasks is not included in any of the one or more provisioning templates.
Aspect 7: The method of any of aspects 1 through 6, further comprising: updating one or more aspects of the software instance associated with the second subset of provisioning tasks based at least in part on receiving an update command.
Aspect 8: The method of any of aspects 1 through 7, wherein the plurality of provisioning tasks comprise one or more software instance setting configuration tasks, one or more software instance layout tasks, one or more software instance metadata tasks, or any combination thereof.
Aspect 9: The method of any of aspects 1 through 8, further comprising: receiving a user survey report indicating one or more configuration preferences associated with the second subset of provisioning tasks, wherein running the second subset of provisioning tasks is based at least in part on the user survey report.
Aspect 10: An apparatus for instantiating a software instance in a multi-phase provisioning procedure comprising a plurality of provisioning tasks, comprising a processor; memory coupled with the processor; and instructions stored in the memory and executable by the processor to cause the apparatus to perform a method of any of aspects 1 through 9.
Aspect 11: An apparatus for instantiating a software instance in a multi-phase provisioning procedure comprising a plurality of provisioning tasks, comprising at least one means for performing a method of any of aspects 1 through 9.
Aspect 12: A non-transitory computer-readable medium storing code for instantiating a software instance in a multi-phase provisioning procedure comprising a plurality of provisioning tasks, the code comprising instructions executable by a processor to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for instantiating a software instance in a multi-phase provisioning procedure comprising a plurality of provisioning tasks, comprising:
identifying a first subset of provisioning tasks associated with a first phase of the multi-phase provisioning procedure and a second subset of provisioning tasks associated with a second phase of the multi-phase provisioning procedure:
running the first subset of provisioning tasks on a plurality of software instances of a pool of software instances prior to a provisioning request for the software instance;
receiving, from a user, the provisioning request;
running, based at least in part on the provisioning request and on the software instance from the pool of software instances, the second subset of provisioning tasks, wherein the second subset of provisioning tasks are specific to the user; and
provisioning the software instance to the user.

2. The method of claim 1, further comprising:
assigning individual provisioning tasks to the first subset of provisioning tasks or the second subset of provisioning tasks based at least in part on one or more dynamicity characteristics of the individual provisioning tasks, a presence or lack of a race condition associated with the individual provisioning tasks, one or more timing parameters associated with the individual provisioning tasks, or any combination thereof.

3. The method of claim 1, further comprising:
dividing a first provisioning task into a first provisioning subtask and a second provisioning subtask based at least in part on one or more dynamicity characteristics of the first provisioning task, a presence or lack of a race condition associated with the first provisioning task, or both;
assigning the first provisioning subtask to the first subset of provisioning tasks; and
assigning the second provisioning subtask to the second subset of provisioning tasks.

4. The method of claim 1, further comprising:
determining that a first attempt to run a first provisioning task of the first subset of provisioning tasks has failed or was not performed; and
assigning the first provisioning task to the second subset of provisioning tasks;
wherein running the second subset of provisioning tasks comprises running a second attempt to run the first provisioning task.

5. The method of claim 1, further comprising:
running the first subset of provisioning tasks based at least in part on one or more provisioning templates stored in a provisioning template database.

6. The method of claim 5, further comprising:
storing an indication of the first subset of provisioning tasks in an additional provisioning template in the provisioning template database based at least in part on running the first subset of provisioning tasks and determining that the first subset of tasks is not included in any of the one or more provisioning templates.

7. The method of claim 1, further comprising:
updating one or more aspects of the software instance associated with the second subset of provisioning tasks based at least in part on receiving an update command.

8. The method of claim 1, wherein the plurality of provisioning tasks comprise one or more software instance setting configuration tasks, one or more software instance layout tasks, one or more software instance metadata tasks, or any combination thereof.

9. The method of claim 1, further comprising:
receiving a user survey report indicating one or more configuration preferences associated with the second subset of provisioning tasks, wherein running the second subset of provisioning tasks is based at least in part on the user survey report.

10. An apparatus for instantiating a software instance in a multi-phase provisioning procedure comprising a plurality of provisioning tasks, comprising:
a processor;
memory coupled with the processor; and
instructions stored in the memory and executable by the processor to cause the apparatus to:
identify a first subset of provisioning tasks associated with a first phase of the multi-phase provisioning procedure and a second subset of provisioning tasks associated with a second phase of the multi-phase provisioning procedure;
run the first subset of provisioning tasks on a plurality of software instances of a pool of software instances prior to a provisioning request for the software instance:
receive, from a user, the provisioning request;
run, based at least in part on the provisioning request and on the software instance from the pool of software instances, the second subset of provisioning tasks, wherein the second subset of provisioning tasks are specific to the user; and
provision the software instance to the user.

11. The apparatus of claim 10, wherein the instructions are further executable by the processor to cause the apparatus to:
assign individual provisioning tasks to the first subset of provisioning tasks or the second subset of provisioning tasks based at least in part on one or more dynamicity characteristics of the individual provisioning tasks, a presence or lack of a race condition associated with the individual provisioning tasks, one or more timing parameters associated with the individual provisioning tasks, or any combination thereof.

12. The apparatus of claim 10, wherein the instructions are further executable by the processor to cause the apparatus to:
divide a first provisioning task into a first provisioning subtask and a second provisioning subtask based at least in part on one or more dynamicity characteristics of the first provisioning task, a presence or lack of a race condition associated with the first provisioning task, or both;
assign the first provisioning subtask to the first subset of provisioning tasks; and
assign the second provisioning subtask to the second subset of provisioning tasks.

13. The apparatus of claim 10, wherein the instructions are further executable by the processor to cause the apparatus to:
determine that a first attempt to run a first provisioning task of the first subset of provisioning tasks has failed or was not performed; and
assign the first provisioning task to the second subset of provisioning tasks;
wherein the second subset of provisioning tasks comprises a second attempt to run the first provisioning task.

14. The apparatus of claim 10, wherein the instructions are further executable by the processor to cause the apparatus to:
run the first subset of provisioning tasks based at least in part on one or more provisioning templates stored in a provisioning template database.

15. The apparatus of claim 14, wherein the instructions are further executable by the processor to cause the apparatus to:
store an indication of the first subset of provisioning tasks in an additional provisioning template in the provisioning template database based at least in part on running the first subset of provisioning tasks and determining that the first subset of tasks is not included in any of the one or more provisioning templates.

16. The apparatus of claim 10, wherein the instructions are further executable by the processor to cause the apparatus to:
update one or more aspects of the software instance associated with the second subset of provisioning tasks based at least in part on receiving an update command.

17. The apparatus of claim 10, wherein the plurality of provisioning tasks comprise one or more software instance setting configuration tasks, one or more software instance layout tasks, one or more software instance metadata tasks, or any combination thereof.

18. The apparatus of claim 10, wherein the instructions are further executable by the processor to cause the apparatus to:
receive a user survey report indicating one or more configuration preferences associated with the second subset of provisioning tasks, wherein the second subset of provisioning tasks is run based at least in part on the user survey report.

19. A non-transitory computer-readable medium storing code for instantiating a software instance in a multi-phase provisioning procedure comprising a plurality of provisioning tasks, the code comprising instructions executable by a processor to:
identify a first subset of provisioning tasks associated with a first phase of the multi-phase provisioning procedure and a second subset of provisioning tasks associated with a second phase of the multi-phase provisioning procedure;
run the first subset of provisioning tasks on a plurality of software instances of a pool of software instances prior to a provisioning request for the software instance;
receive, from a user, the provisioning request;
run, based at least in part on the provisioning request and on the software instance from the pool of software instances, the second subset of provisioning tasks, wherein the second subset of provisioning tasks are specific to the user; and
provision the software instance to the user.

20. The non-transitory computer-readable medium of claim 19, wherein the instructions are further executable by the processor to:
assign individual provisioning tasks to the first subset of provisioning tasks or the second subset of provisioning tasks based at least in part on one or more dynamicity characteristics of the individual provisioning tasks, a presence or lack of a race condition associated with the individual provisioning tasks, one or more timing parameters associated with the individual provisioning tasks, or any combination thereof.
